(19) United States
(12) Patent Application Publication
(10) Pub. No.: US 2011/0014595 A1
(43) Pub. Date: Jan. 20, 2011

(54) Partner Assisted Communication System and Method

(76) Inventor: Sydney Birr, Eustis, FL (US)

Correspondence Address: THE PATENT GUILD, 313 COURTNEY SPRINGS CIRCLE, WINTER SPRINGS, FL, 32708, US

(21) Appl. No.: 12/840,264

(22) Filed: Jul. 20, 2010

Related U.S. Application Data
(60) Provisional application No. 61/271,293, filed on Jul. 20, 2009.

(51) Int. Cl. G09B 5/04

(52) U.S. Cl. 434/185

(57) ABSTRACT

The present invention relates a partner assisted voice output communication method to aid individuals of all ages with overcoming verbal language expression difficulties. This method is conducted in conjunction with an interactive voice output device as a teaching tool which allows a child/learner—by pressing buttons/symbols provided on an overlay—to see and hear words in average daily activities and selected activities. The learner's partner, teacher, or guide uses this tool to model single words in context or combines 2 or more words while speaking in a natural voice, increasing functional, effective, interactive verbal communication. Strategies and supplemental training aids for using the method and device to engage the language learner/student are disclosed.

This application claims the benefit of provisional patent application No. 61/271,293 filed Jul. 7, 2009.

### BACKGROUND OF THE INVENTION

### Field of the Invention

The present invention presents a partner assisted communication method to aid individuals of all ages with overcoming verbal language expression difficulties. The method disclosed herein is performed by using a unique voice output device as disclosed herein. This teaching method, when combined with the voice output device, allows a child/learner/student—by pressing buttons/symbols provided on an overlay on the voice output device—to see and hear words as they are used in functional daily activities and structured activities and uses words most frequently used in various interactive communicational situations. The language learner/student's partner, teacher, or guide uses the methods disclosed herein to model single words in context or combines 2 or more words while speaking in a natural voice, increasing functional, effective, interactive verbal communication. A variety of strategies for using the device to engage the early learner are suggested.

According to educators, a vocabulary of 500 words is enough for limited communication of wishes and needs. Basic conversation requires about 1000 words plus some knowledge of verb tenses. With 100 of the most frequently used words for social interactions, the language learner/student is well on their way to tackling a language challenges, including learning foreign languages.

Currently, there are a wide variety of voice output devices available for those people who face difficulty with verbal language expression. For example U.S. Pat. No. 3,389,480 presents a game and teaching method for teaching the parts of speech and their relationship to each other using colored cards. U.S. Pat. No. 3,854,131 teaches a communication device is provided for handicapped persons, such as persons suffering from cerebral palsy who are unable to speak, write, or operate a typewriter. U.S. Pat. No. 4,197,661 presents an educational toy. U.S. Pat. No. 4,215,240 presents a portable voice system for the verbally handicapped. U.S. Pat. No. 4,493,050 presents an electronic translator. U.S. Pat. No. 4,785,420 presents an audio/telephone communication system for verbally handicapped individuals. U.S. Pat. No. 5,097,425 presents a predictive scanning input system for rapid selection of visual indicators. U.S. Pat. No. 5,309,546 presents a system for method for producing synthetic plural words messages. U.S. Pat. No. 5,556,283 presents a card type of electronic learning aid/teaching apparatus. U.S. Pat. No. 5,733,128 teaches a language learning aid and method. U.S. Pat. No. 5,854,997 teaches an electronic interpreter utilizing linked sets of sentences. U.S. Pat. No. 5,910,009 teaches a communication aid using multiple membrane switches. U.S. Pat. No. 5,902,112 teaches speech assisted learning. U.S. Pat. No. 5,920,303 teaches dynamic keyboarding and method for dynamically redefining keys on a keyboard. U.S. Pat. No. 6,068,485 teaches a system for synthesizing spoken messages. US Patent Publication 2006/0020470 A1 teaches an interactive speech synthesizer. US Patent Publication 2008/0183460 teaches an apparatus, method and computer readable medium for Chinese character selection and output.

Recordable single message symbol/buttons use a single switch. More complex devices with 4 to 12 message locations with multiple levels have multiple overlays. There are computers with complex dynamic displays with over 100 locations with dedicated software for use with touch screen and a variety of switches to use with scanning methods of selection as well as hand held computers and smart phones. In other words, each person has a different, custom voice output tools tailored to their changing language needs with changing picture symbols and/or words to coordinate with each unique activity throughout each day. This attention to the details of the multiple needs of each person requires extensive training of teachers, therapists, aides, parents, adults and children. Concentrated periods of time apart from the regular classroom or home, substantial financial output along with downtime for repairs and those related costs means loss of time from effective means of communication.

Despite the abundance of advanced language assistance products, the need remains for a partner assisted communication method which employs a simple voice output device to train communication partners or guide them in increasing the functional, effective, interactive verbal communication of a learner using 100 of the most frequently used words. The present invention and inventive language learning method provides a learning methodology whereby participants naturally practice their verbal skills while engaged in educational and leisure activities.

### SUMMARY OF THE INVENTION

This invention provides a method for learning a core vocabulary of high frequency use words which is easily accessible in all environments to those individuals needing verbal communication. There is no need for a computer, software, battery charger, on/off switch, volume control, programming skills, or electronically changing picture symbol displays or pages. The learning method herein offers an opportunity for effective functional interactive communication for a wide variety of applications and users, such as individuals with: developmental delay, visual needs, autism, cognitive impairment, hard of hearing, brain injury, motor planning difficulty, cerebral palsy, apraxia, selective mute, voice, speech and language disorders, foreign language, beginning language learners. The relative ease of use of the present learning method will allow more individuals to communicate more frequently. It will promote faster language acquisition and increased verbal expression using the person's natural voice in his/her primary language, thereby relying less and less on the voice output device. As the language learner's skills increase, this learning method provides the foundation and knowledge for the listener and speaker (both communication partners) to transition to using more complex technology or their natural voice and alternative language strategies as needed.

Generally the present invention presents a method for partner assisted language communications between a language learner/student and a language partner including: providing a voice output device wherein the voice output device includes a sound output component for enunciating word/audio files, an overlay having sound activating symbols, and at least one activatable word/audio file which corresponds to each sound activating symbol; performing an assessment of the language level of the language learner/student to determine language learning deficiencies or proficiencies; generating or selecting a learning plan for the language learner/student to address language learning deficiencies or proficiencies identified in the assessment of the language learner; implementing the learning plan; monitoring the language learner/student's responses to the tasks of the learning plan; assessing the language learner/student's responses to the tasks of the learning plan; revising the learning plan to address language learning deficiencies or proficiencies identified in the assessment of the language learner/student's responses to the tasks of the learning plan; implementing the revised learning plan.

The present invention also presents a voice output device for partner assisted language communications between a language learner/student and a language partner including: a housing including a sound output component; an overlay attached to the housing, the overlay containing at least one sound activating symbol, wherein pressing the symbol activates a corresponding audio file thereby causing the sound output component to enunciate the sound of the word of the selected audio file; wherein the overlay contains a plurality of columns and rows of sound activating symbols arranged in pre-specified colors and order with regards to nouns, verbs, prepositions, adjectives, clarifying words, and questions.

### BRIEF DESCRIPTION OF THE DRAWINGS

FIG. 1a is a perspective image of the voice output device.

FIG. 1b is a top view of the voice output device.

FIG. 2 is a rear view of the symbol panel.

FIG. 3 is symbol overlay panel.

FIG. 4 is exemplary communication and interaction activities.

FIG. 5 is an exemplary child response diagram.

FIG. 6 is an Interactive Communication Flowchart.

FIG. 7 is a First Words Tracking Form.

FIGS. 8a-8e are an Articulation Tracking Form.

FIG. 9 is an outline of steps for success using the presented method.

FIG. 10 is a Conversation Interaction Tracking Form.

FIG. 11a is the left side of the Spanish version overlay template.

FIG. 11b is the right side of the Spanish version overlay template.

FIG. 12 is the left side of the Chinese version overlay template.

FIG. 13a is the left side of the Communications Board template.

FIG. 13b is the right side of the Communications Board template.

### DETAILED DESCRIPTION OF THE PREFERRED EMBODIMENT

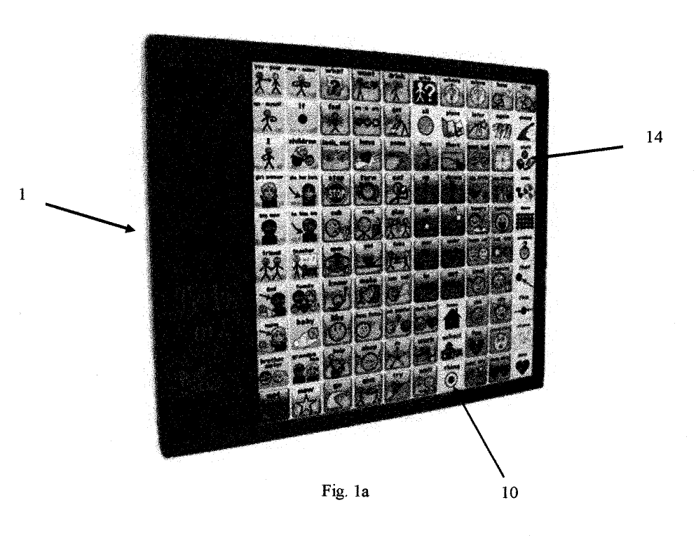

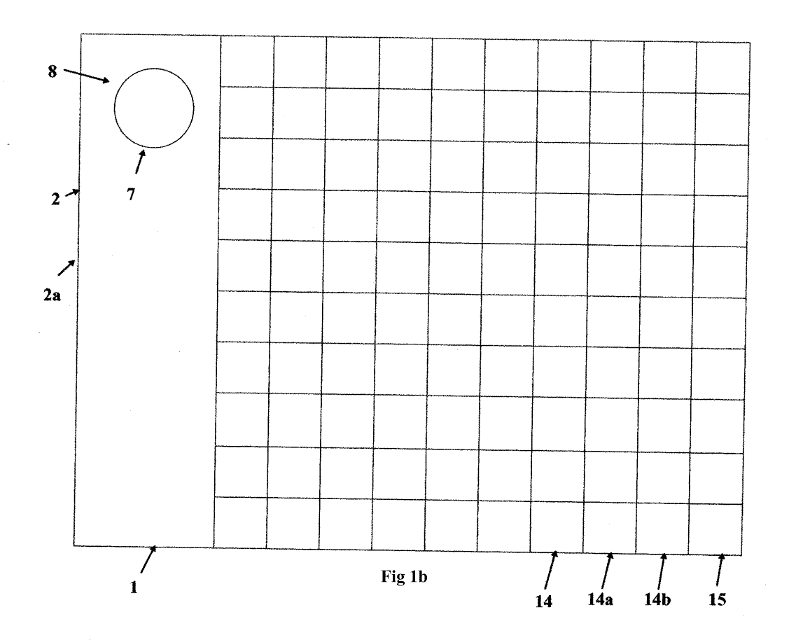

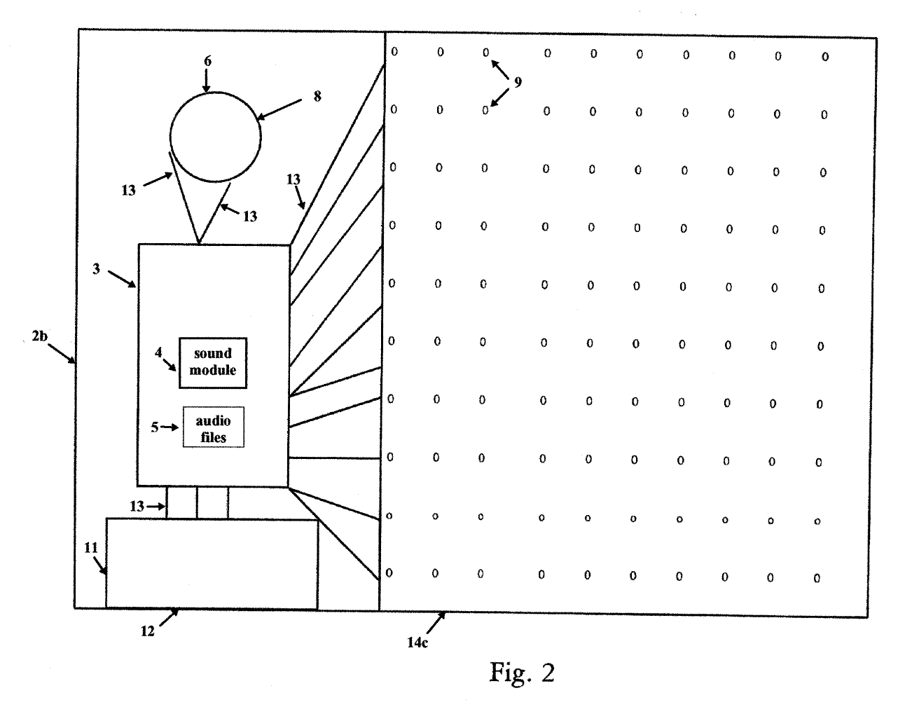

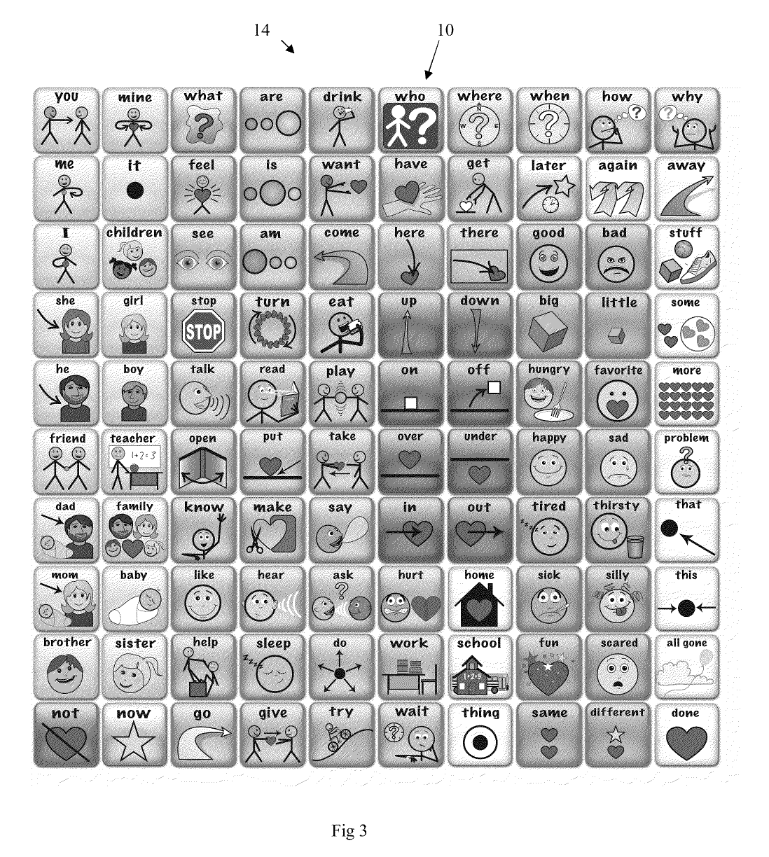

The preferred embodiment of the voice output device 1, as shown in FIGS. 1a-3, includes a case/housing 2 (such as a plastic case which is 12″ width, 10″ height, ½″ depth), the case/housing 2 includes a front section 2a and a back section 2b.

The voice output device 1 includes a printed circuit board 3 positioned within the case/housing 2 between the front section 2a and the back section 2b, the printed circuit board 3 includes a sound module 4 (such as an electronic memory location) which stores audio files 5 in a learner's primary language as well as supplemental audio files such as audio files of additional users and other sounds. An exemplary audio file 5 would contain 100 words and be approximately 2 minutes in length (approximately 1.5 seconds for each word). Audio files 5 may be prerecorded in a variety of languages by female and male children and adult voices.

The voice output device 1 includes at least one speaker 6 and speaker grill 7 attached to the case/housing 2. For example the speaker 6 and speaker grill 7 may be positioned within a plastic mould 8 in the upper left hand corner of the front section 2a of the voice output device 1. The speaker will emit the sound level of a normal speaking voice including but not limited to 65 to 70 dB.

The voice output device 1 includes a power source 11 (such as batteries) housed inside the mould 8, a power source sliding door cover 12 on the back section 2b of the case/housing 2, and wires 13 interconnecting case/housing components.

The voice output device 1 includes a symbol panel/overlay 14 having a protective layer 14a (such as a lamination layer) provided over a symbol indicia layer 14b (such as a layer of paper) further positioned over a circuit substrate layer 14c. The circuit substrate layer 14c contains switches 9 which are aligned to correspond symbols 10 (which may include printed words and/or color-coded pictures) on the symbol indicia layer 14b to the appropriate audio file 5.

When a user presses the desired symbol 10 shown on the symbol indicia layer 14b, the audio file 5 associated with symbol 10 is played through the speaker 6.

The circuit substrate layer 14c may be a magnetic layer 15 positioned between each symbol 10 and a corresponding switch 9. The symbol panel/overlay 14 is exposed on the front portion 2a of the case/housing 2.

The voice output device 1 includes interconnecting tabs 16 which connect the front and back section of the case/housing 2 together.

Directions for partner-assisted communication may be provided on the case/housing 2.

Additional overlays 14d (not shown) may be provided to fit over the switch symbols 10 and can be attached with tabs at the edge of the case/housing 2 which can include, for example printed words specific to a foreign language such as Spanish, French, Japanese, etc. The additional overlays 14d can be provided over selected sections of the overlay symbols 10 or over the entire overlay 14. Audio files 5 may contain a foreign language translation of the selected symbol 10.

An optimized tactile overlay 14e (not shown) for the visually impaired may be provided to fit over the switch symbols 10. The tactile overlay 14e can be provided over selected sections of the overlay symbols 10 or over the entire overlay 14. The tactile overlay 14e is optimized to present unique raised embossing which represents the corresponding symbol 10.

The voice output device 1 may include 1 to 100 or more switch/symbol/audio file combinations. For example a voice output device may provide 25 or 50 switch/symbols on the overlay which correspond to the applicable audio files.

The preferred embodiment of the partner assisted communication method includes providing a voice output device wherein the voice output device includes a sound output component for enunciating word/audio files, an overlay having sound activating symbols, and at least one activatable word/audio file which corresponds to each sound activating symbol; performing an assessment of the language level of the language learner/student to determine language learning deficiencies or proficiencies; generating or selecting a learning plan for the language learner/student to address language learning deficiencies or proficiencies identified in the assessment of the language learner; implementing the learning plan; monitoring the language learner/student's responses to the tasks of the learning plan; assessing the language learner/student's responses to the tasks of the learning plan; revising the learning plan to address language learning deficiencies or proficiencies identified in the assessment of the language learner/student's responses to the tasks of the learning plan; implementing the revised learning plan.

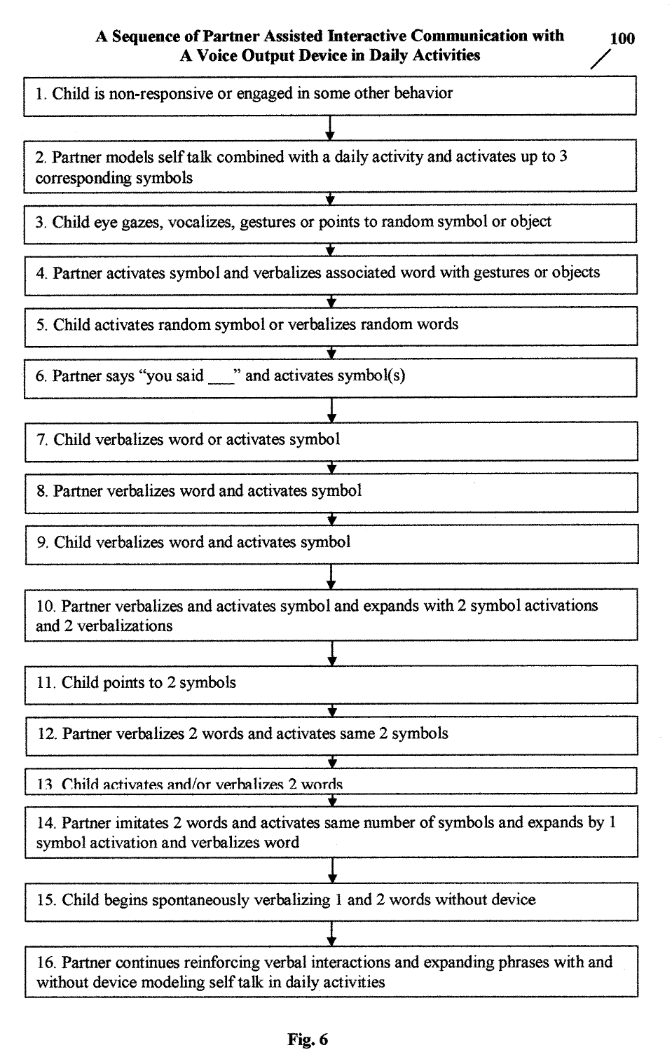

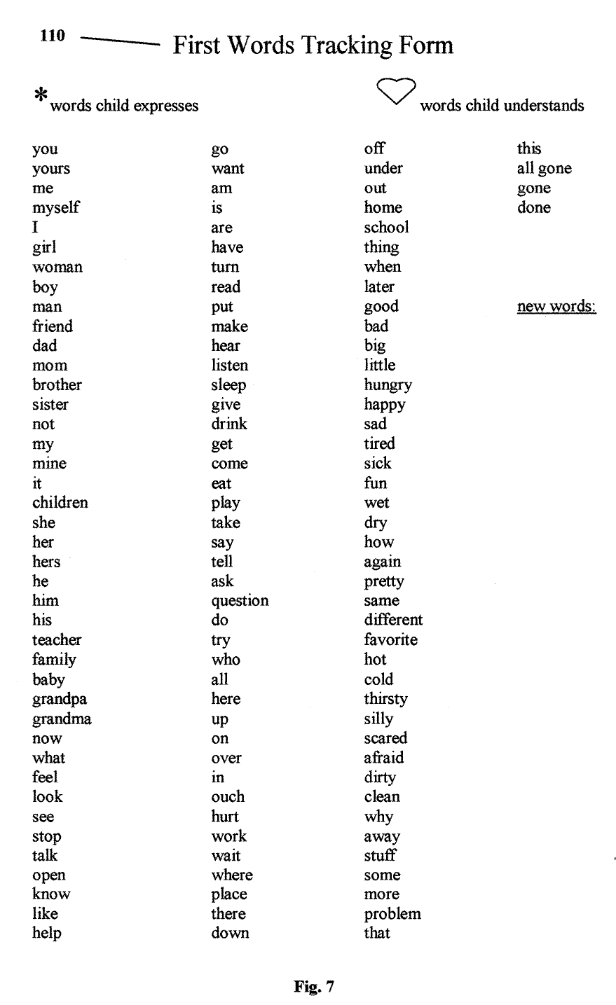

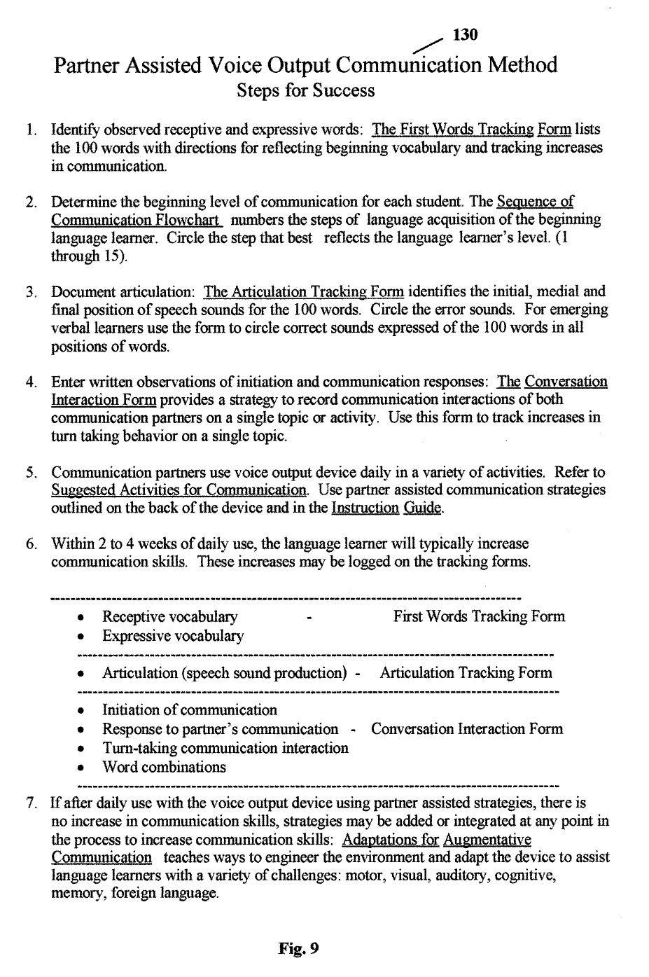

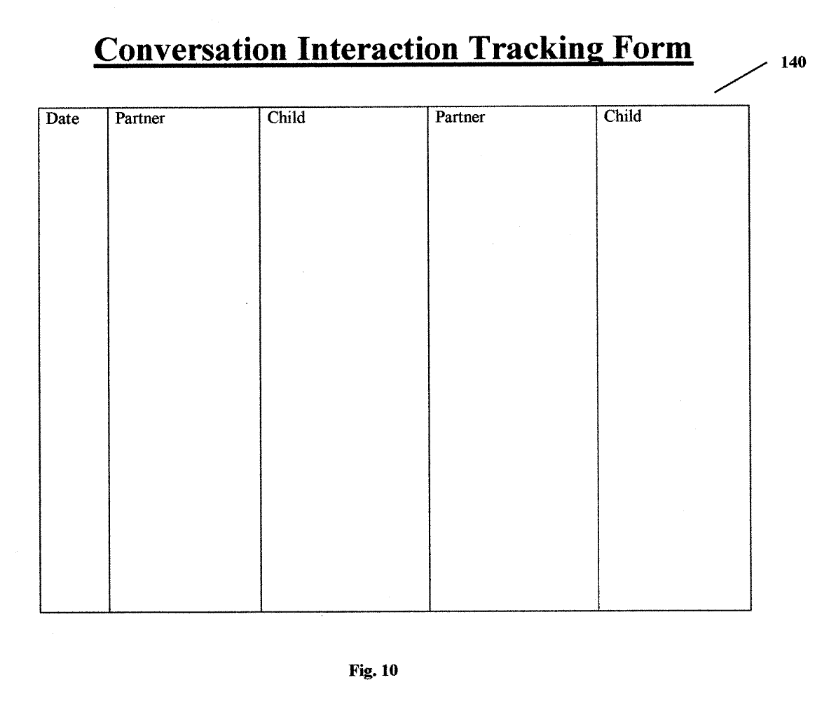

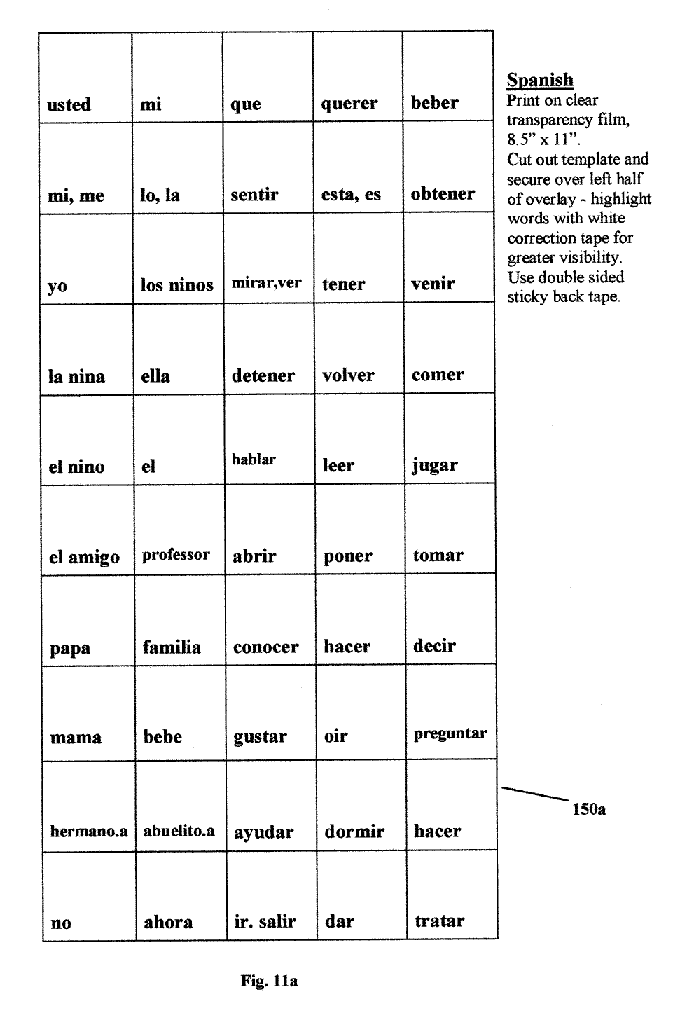

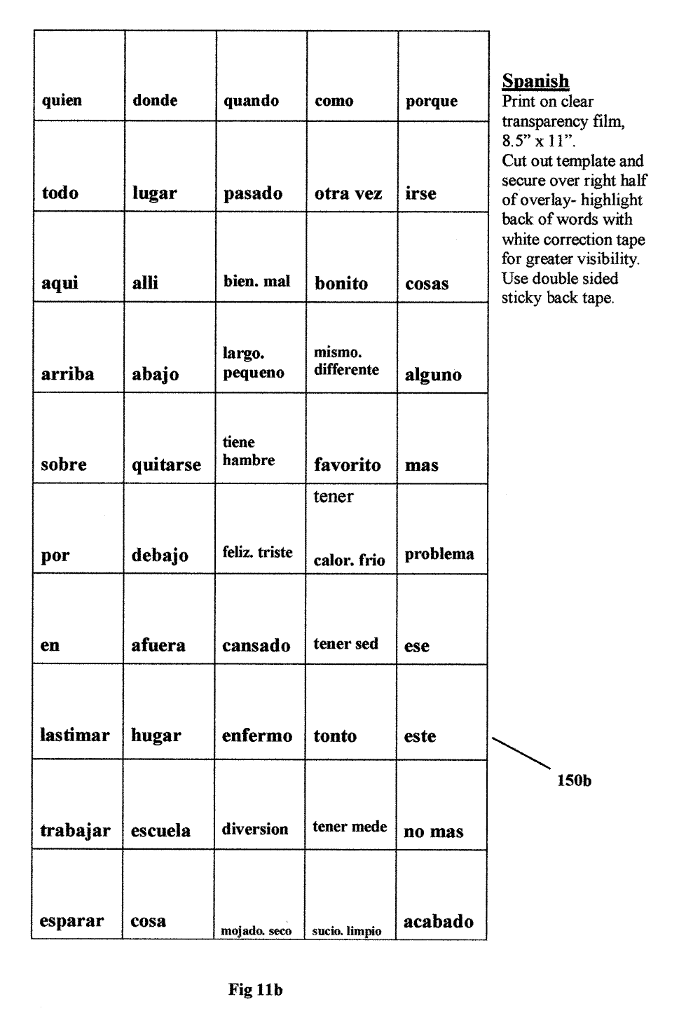

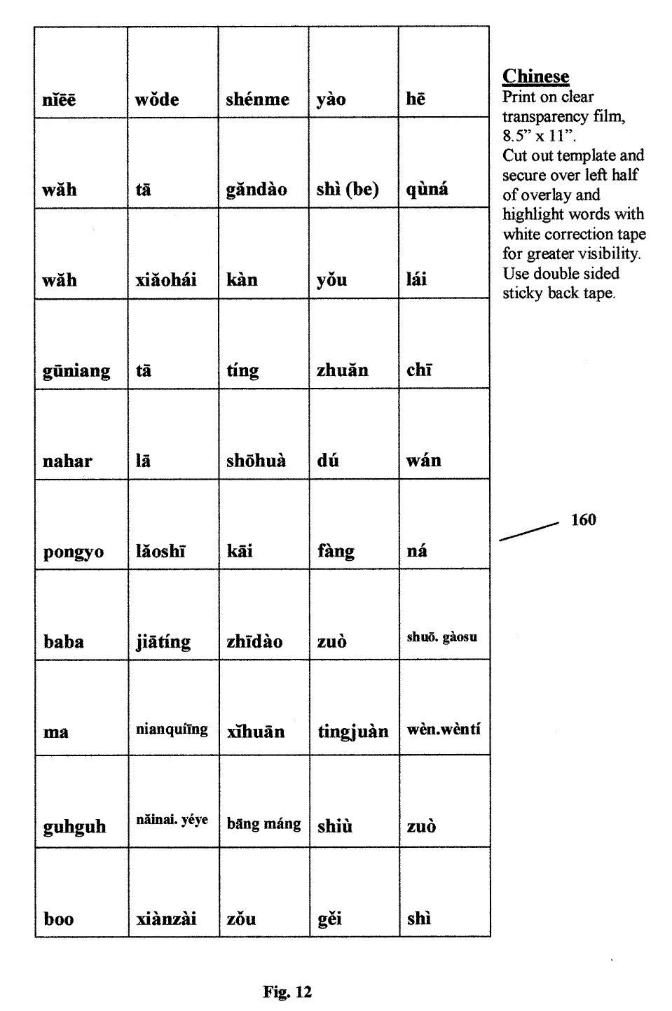

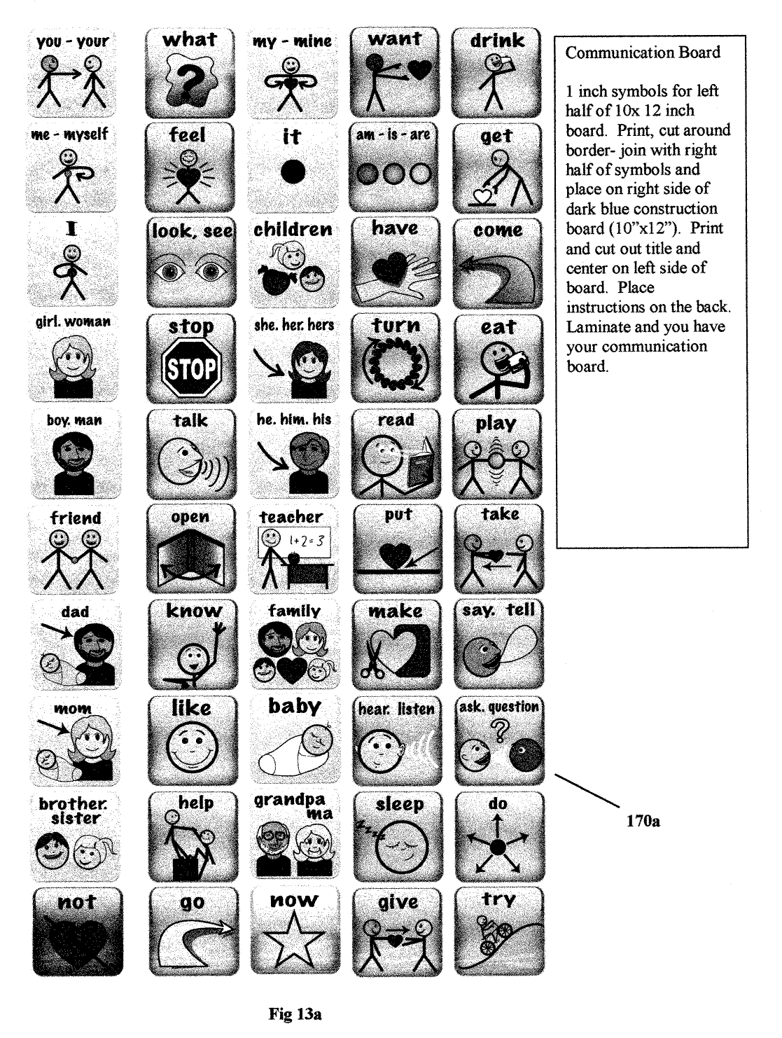

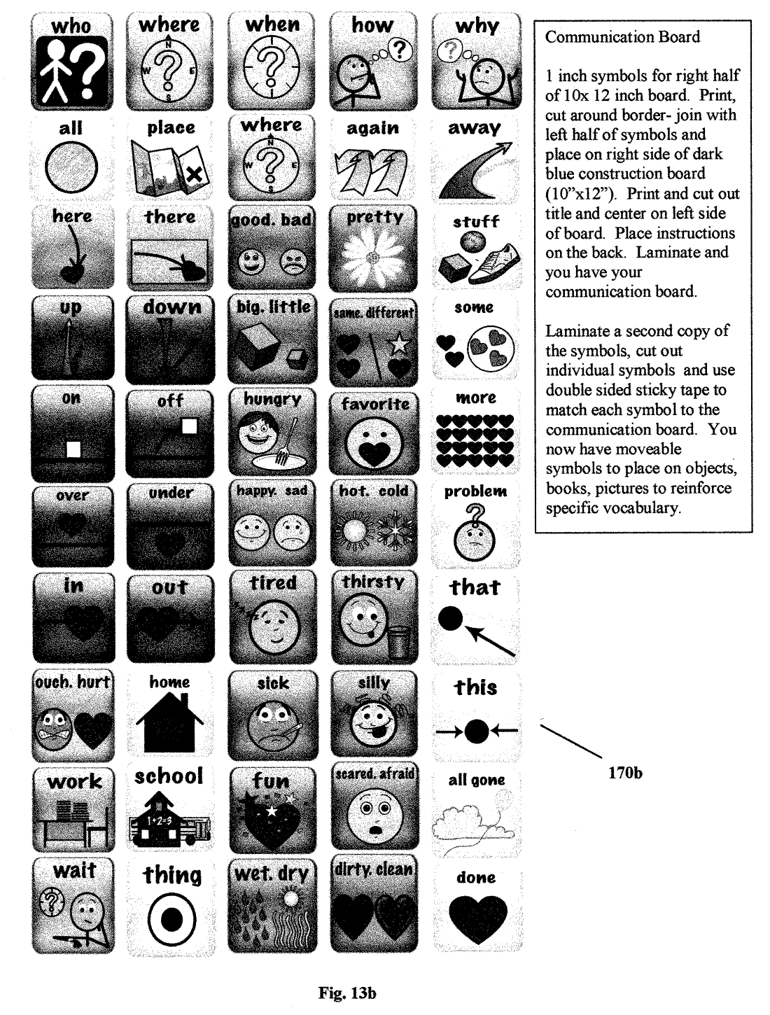

Performing the assessment of the language level of the language learner/student to determine language learning deficiencies or proficiencies is conducted by using the provided Interactive Communication Flowchart 100 (FIG. 6), First Words Tracking Form 110 (FIG. 7), and Conversation Interaction Tracking Form 140 (FIG. 10) in conjunction with daily activities of the learner to indicate the learners communication level and vocabulary. The Steps for Success diagram 130 (FIG. 9) provides an outline of when to use the appropriate forms.

On the Interactive Communication Flowchart 100 the best step that reflects the learner's communication level is selected. On the First Words Tracking Form 110 the words provided are the words presented on the overlay 14 of the voice output device. Learning partners circle the words the learner/student expresses (expressive vocabulary) and also circles the words which the child demonstrates understanding (receptive vocabulary). Additionally, the learning partner can note new words expressed by the learner/student. On the Conversation Interaction Tracking Form 140 the learner/student and learning partner participation level in performing the tasks and activities is note such as by noting the number of turn takings which were conducted during the task or activity.

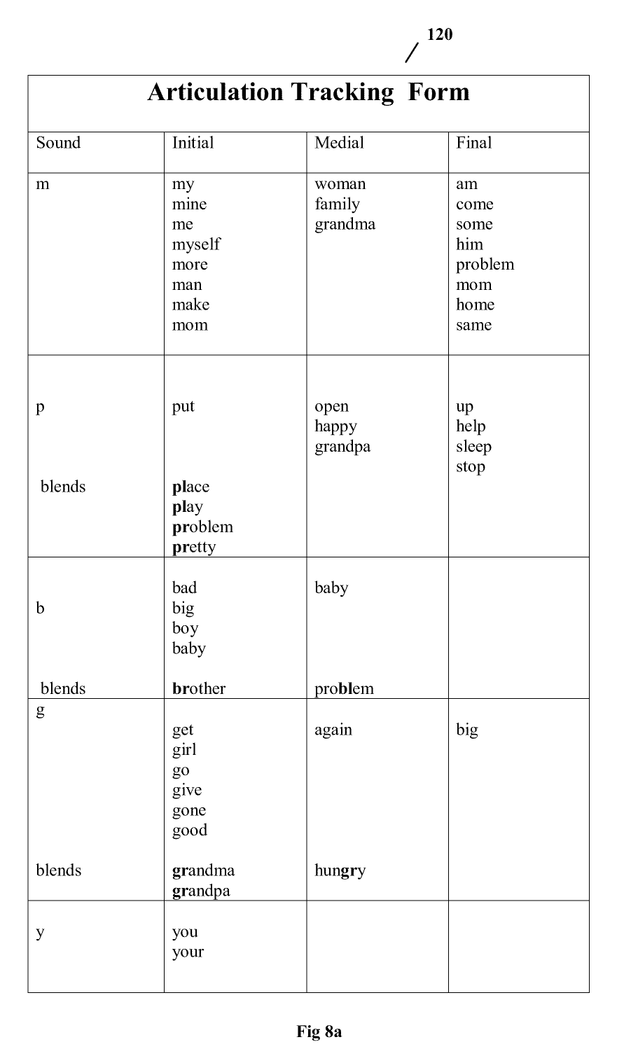

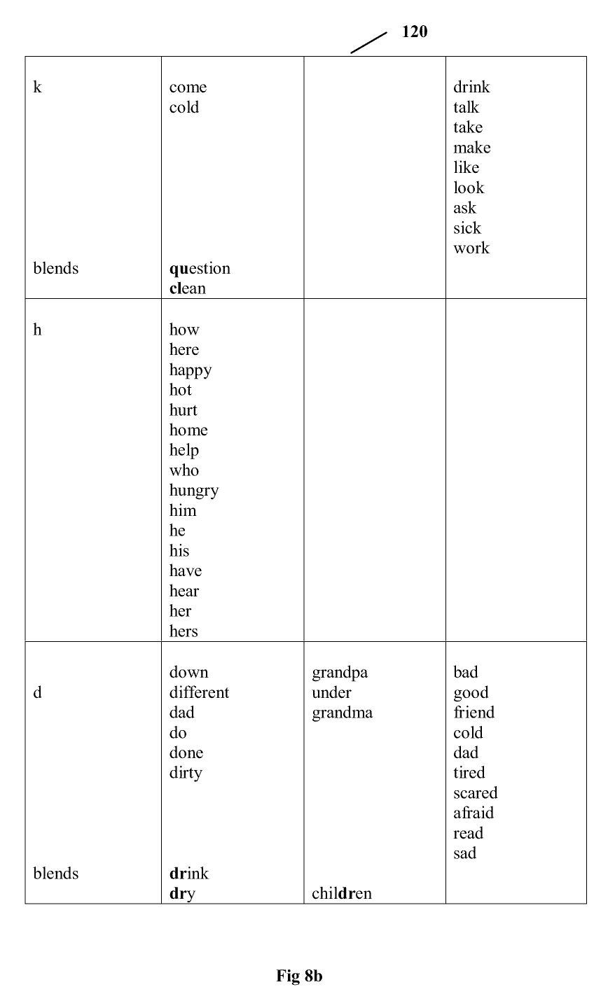

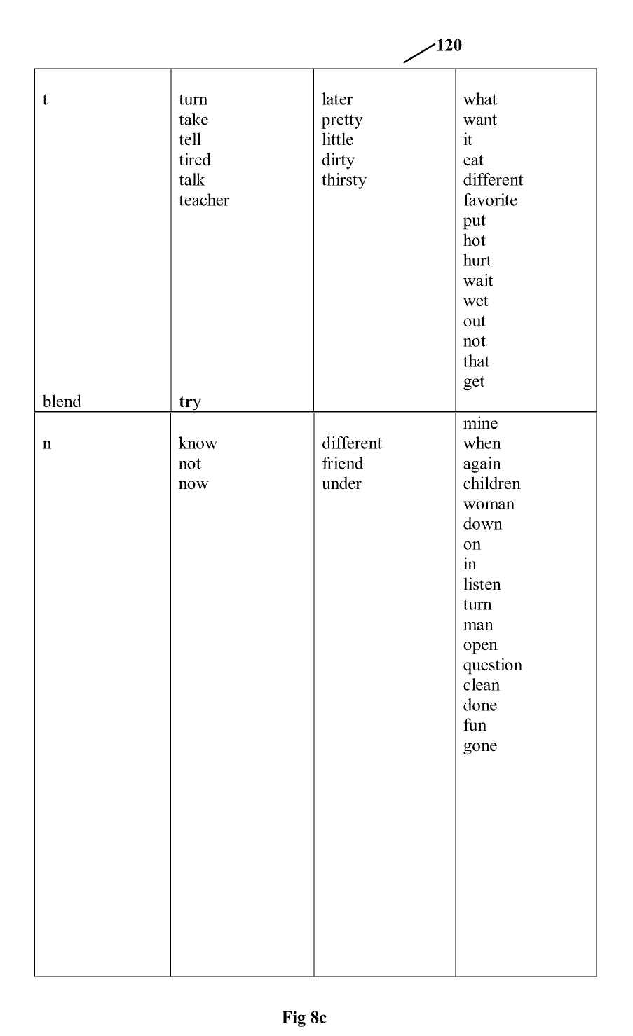

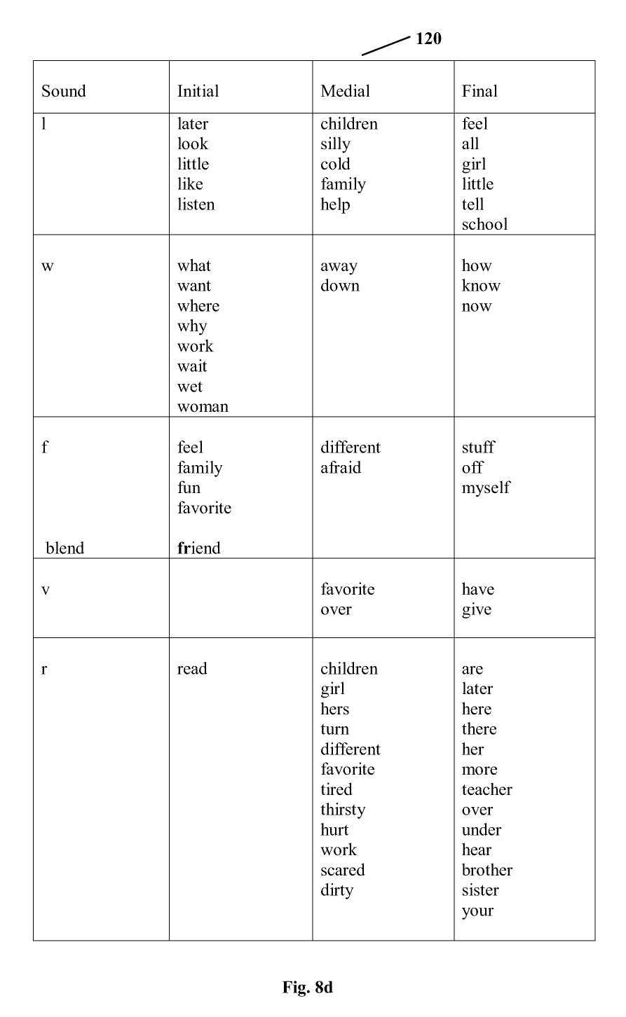

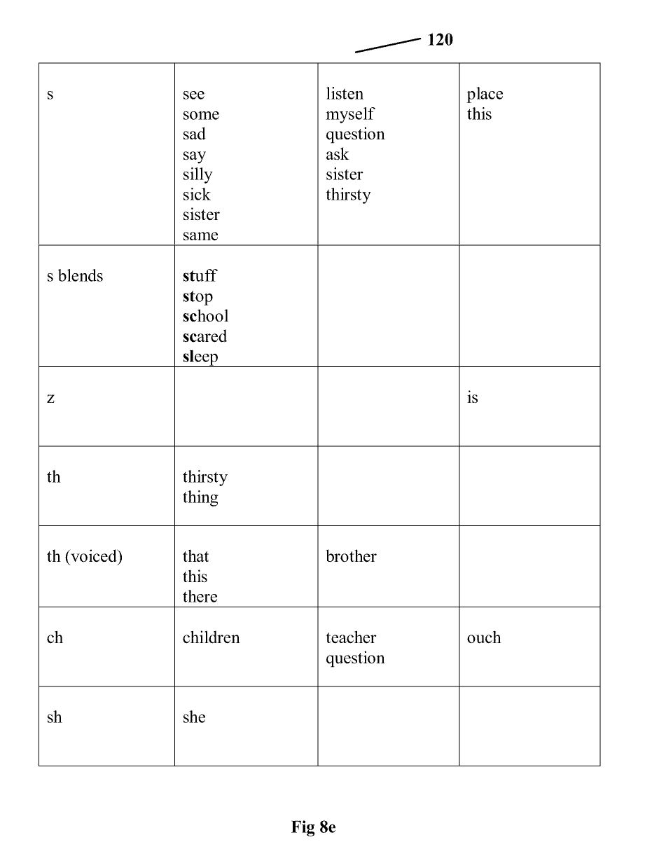

The assessment further includes selecting and documenting the words that reflect the current vocabulary of the language learner/student from among a predetermined group of words; selecting from among the flow chart of interactive communication steps the best step that reflects the interactive communication level of the language learner/student during interactive communication activities; and documenting the articulation level of the language learner/student by indicating on an Articulation Tracking Form 120 (FIGS. 8a-8e) the position of selected portions of speech key sounds of words enunciated by the language learner/student during interactive communication activities and noting words incorrectly enunciated by the language learner/student.

The tracked positions of selected portions of key speech sounds as presented on the Articulation Tracking Form 120, are the initial position, the medial position, and the final position, wherein the tracked positions indicate whether the key speech sound is appropriately positioned at the initial (beginning) position of a word, the medial (middle) position of a word, or the final (end) position of a word when the word is enunciated correctly. The Articulation Tracking Form 120 allows learning partners to easily assess the enunciation of words expressed by the learner/student and allows the learning partner to note the progress (or lack of progress) in enunciating words as the learner/student participates in the learning activities.

Generating or selecting a learning plan for the language learner/student to address language learning deficiencies or proficiencies identified in the assessment of the language learner includes selecting at least one target word from the vocabulary of the language learner/student which was determined to be incorrectly enunciated during the assessment of the language level of the language learner/student; and selecting a task/activity for interactive communication between the language learner/student and the language partner which is suitable for use with the at least one target word and the voice output device.

A variety of learning activities are disclosed herein (such as the below activities which utilize supplemental training aids). In generating or selecting a learning plan, the information obtained via the Interactive Communication Flowchart 100, the First Words Tracking Form 110, the Articulation Tracking Form 120 and the Conversation Interaction Tracking Form 140, are combined to determine the level of the learner/student vocabulary as well as to determine the appropriate interactive communication step most suitable for the learner/student.

For example, if the learner/student actively verbalizes single words and activates the appropriate symbol(s), the learning partner would generate a learning plan wherein the learner/student is tasked to verbalize 2 or more words together and activate the appropriate combination of word symbols on the voice output device. Additionally, the learning partner may generate a learning plan which uses supplemental training aids which focuses the language learner/student's attention on the at least one target word such as a template which selectively covers symbols from view.

In implementing the learning plan the language partner initiates a conversation or the selected task/activity with the language learner/student which uses the voice output device and is intended to elicit the enunciation of at least one target word by the language learner/student.

In monitoring the language learner/student's responses to the tasks of the learning plan additional documenting of the articulation level of the language learner/student is performed by further indicating on the Articulation Tracking Form 120 the position of selected portions of speech sounds of words enunciated by the language learner/student during the conversation or the selected task/activity and noting words incorrectly enunciated by the language learner/student.

In assessing the language learner/student's responses to the tasks of the learning plan the articulation level of the language learner/student is evaluated to determine how accurately the learner/student articulated target words. Additionally, the suitability of the selected task or activity for eliciting the enunciation of the target word(s) is assessed such as by counting the number of target words spoken by the learner/student during the activity.

Revising the learning plan to address language learning deficiencies or proficiencies identified in the assessment of the language learner/student's responses to the tasks of the learning plan is performed by incorporating information from the Interactive Communication Flowchart 100, the First Words Tracking Form 110, the Conversation Interaction Tracking Form 140, and the Articulation Tracking Form 120. The results of the learner/student's performance is used to determine the most suitable follow-up learning tasks or activities.

For example, if a target word such as “open” was not spoken by the learner/student during the selected task or activity, the revised learning plan would include an alternate activity which is more likely to elicit the learner/student to enunciate the word “open”. Further, if the Articulation Tracking Form 120 indicates the learner/student incorrectly enunciate the “o” in “open, alternate words which begin with “o” may be selected in the revised learning plan.

Specifically, revising the learning plan includes selecting at least one target word determined to be incorrectly enunciated by the language learner/student; and selecting an alternative task/activity for interactive communication between the language learner/student and the language partner which is intended to elicit the enunciation of the at least one target word by the language learner/student.

Further, revising the learning plan may include: selecting at least one target word determined to be incorrectly enunciated by the language learner/student; and selecting at least one alternative word wherein the tracked position of the key speech sound of the target word is enunciated at the same initial, medial, or final position of the alternative word when the alternative word is enunciated correctly.

Revising the learning plan may combine an alternate task/activity with the selection of at least one alternative word such as by selecting at least one target word determined to be incorrectly enunciated by the language learner/student; selecting at least one alternative word wherein the tracked position of the key speech sound of the target word is enunciated at the same initial, medial, or final position of the alternative word when the alternative word is enunciated correctly; and selecting an alternative task/activity for interactive communication between the language learner/student and the language partner which is which is intended to elicit the enunciation of the alternative word by the language learner/student.

Additionally, revising the learning plan presents an opportunity to target specific aspects of the learner/student language skills for improvement. On the overlay 14 of the voice output device 1 the sound activating symbols representing parts of speech and vocabulary are arranged in pre-specified colors as well as row and column order with regards to nouns, verbs, prepositions, adjectives, clarifying words, and questions.

For example, nouns are presented in yellow and positioned in the left first two columns, verbs are presented in green and positioned in columns 3 thru 5, prepositions are presented in purple and positioned in columns 6 thru 7, adjectives are presented in blue and positioned in columns 8 thru 9, clarifying words are presented in white and positioned in column 10 and around the perimeter of the overlay, and questions are presented in grey and positioned in the top row of the overlay.

Further, revising the learning plan may include modifications to the Interactive Communication Flowchart 100, the First Words Tracking Form 110, and/or the Articulation Tracking Form 120.

It is envisioned that the layout format and color coding of the sound activating symbols 10 on the overlay 14 can be rearranged and re-colored as needed and that that the layout format and color coding presented herein is both exemplary (in that it shows the uses of color as related to the positions of the sound activating symbols) and unique (in that it presents a specific configuration which correlates symbol color as related to the overlay layout positions of the sound activating symbols with specific portions of vocabulary—such as nouns, verbs, prepositions, adjectives, clarifying words, and questions).

A significantly novel aspect of the present invention is that the sound activating symbols 10 can be presented in an arrangement which optimizes and reinforces language learning when used with the partner assisted voice output communication method presented herein because learners can quickly locate the appropriate symbol 10 and learning partners can easily strategically plan the learning task or activity.

For example, if the learning partner generated a learning plan to focus on the learner/student's ability to enunciate verbs, the learning partner would simple employ supplemental training aids which cover or uncover green symbols 10. Additionally, the symbol color coding and locational format allows the learning partner to provide color or location hints to the learner/student and guide the learner/student to the correct sound activating symbol 10 (rather than merely point to the correct symbol) thereby increasing the level of interaction between the learner/student and learning partner.

Further multiple colors of speech symbols 10 can be selected to form combinations of words thereby representing phrases, statements, or questions. For example learning partners can have the learner/student use a word from each color to develop a phrase. Generally learning partners can have the learner/student construct phrases which include or exclude word symbols 10 from a particular color group and/or include or exclude word symbols which are positioned in specified locations (such as in the first two columns or around the perimeter).

Implementing the learning plan includes wherein the language partner initiates a conversation or the selected task/activity with the language learner/student which uses the voice output device and is intended to elicit the enunciation of at least one target word by the language learner/student.

The learning method disclosed herein is particularly amenable to variations through the use of Supplemental Training Aids including (but not limited to):

1) A blanking template with removable individual squares to allow specific windows to reveal target words, reducing visual stimulation. An exemplary blanking template is created by a) printing 100 square blank template on 8.5″×11″ poster paper and laminate, b) determining target vocabulary to be enunciated, and c) cutting out corresponding window like squares so that only the target vocabulary is visible through the cut-out window in the blanking template. It is useful to begin with only 3 to 8 symbols exposed, depending on the ability of the language learner/student. Even though this template may not prevent activation of the “hidden” words, the configuration of preselected windows will encourage repetition of the targeted vocabulary by both communication partners.

2) A customized visual template having individualized digital photos of people, actions, places and pictures. Insert or import your photos, symbols or pictures onto the template, print and attach to symbol overlay on the voice output device. Print a copy to laminate and cut individual pictures to use as a moveable communication board (see FIGS. 170a and 170b).

3) A foreign language template (see FIGS. 150a, 150b, and 160) (such as French, Spanish, Italian, German, Chinese, Japanese, etc) printed on clear 8.5″×11″ sheets which are then placed over existing voice output device symbols. It may be helpful to coat the back of the foreign language words with “White-Out®” or white correction tape so that the foreign language word is very visible against the symbol.

4) A tactile grid template to assist visually impaired individuals. Print an empty 100 square grid having no symbols on an 8.5″×11″ poster sheet and position in on the overlay of the voice output device. Laminate and cut out individual selected target squares (representing target words). As the communications session progresses individually add additional target squares to the tactile grid template. As the language learner/student gains comprehension and expressive skills, increase number of cut out squares until each square is outlined with the poster grid. The tactile and auditory feedback from left to right and top to bottom will reinforce location of words. Follow the partner facilitated instructions as you combine language in functional and interactive daily activities.

5) Simultaneous multiple voice output device usage—each participant uses their own voice output device in conjunction with the suggested communications methods to give participants more control over who uses his/her “voice”. Recent research suggests that augmentative communication users learn best when they have their individual voice output device.

6) A software application for mobile devices (such the Apple iphone) provided in conjunction with the voice output device 1 of the present invention to interface the mobile device with the voice output device 1. Using this software application the mobile device user and the user of the voice output device 1 of the present invention can communicate interactively using current telecommunication technology in combination with unique visual overlays, symbols, and the learning methodology as described above and explained below. For example, the voice output device 1 may have a transmitter and receiver dedicated to using 100+ words to communicates with the mobile device users by correlating, transmitting, and receiving the 100+ symbols and words in conjunction with an overlay pattern provided by the present invention.

7) A website is provided which is dedicated to enhance teaching the usage of partner assisted voice output communication strategies using the voice output device of the present invention. The website provides:

A. Detailed description of partner facilitated strategies for communication with links to recognized experts in the field of Speech and Language Pathology.

B. Video segments of students using invention at intervals (such as monthly intervals) to document progress of verbal expression interactions with different individuals in a variety of activities and environments.

C. Research studies of current methods of teaching verbal expression using existing voice output devices and visual strategies compared to results of language learners using this invention. Provide evidence-based samples of individuals gaining verbal expressive skills using this invention.

D. Charts and graphs of normal language development with links to national and state organizations as additional resources.

E. Files of 100 symbols in a variety of sizes and arrangements available for download to individual users. Information includes adaptations using lamination and Velcro® of symbols, PVC constructions of frames to adapt device for better access to those individuals with special needs. Adapted songs, rhymes and books with the 100 symbols to demonstrate motivating and effective ways to increase verbal expression.

F. Templates of the 100 symbol/buttons with a picture library of gradually more realistic pictures to generate a more individualized overlay as a child increases his/her ability to integrate more complex visual images into his/her increasing language comprehension and expression skills. Ultimately, digital photographs of the real representation of these words (ex: I, mother, father, home, work, eat, drink, etc.) may be used to replace simpler versions of the symbols. This level would reflect a significant growth in language comprehension and expression. These new overlays can be easily attached to the original overlay on the voice output device.

G. The website can be enhanced by voice technology for access to the blind; directions will be available in multiple languages; scanning access will be provided for physically impaired individuals. This voice output device will be available online using a touch screen, mouse or touch pad on individual computers.

H. Guidance and resources to Augmentative and Alternative Communication websites and Assistive Technology links for communication development.

8) Symbol stickers to place in books. Decide the target symbols to use with the learner. Open blank document on a computer, insert selected symbols (available from CD or downloaded file) to correspond with words in specific stories. Print on 8.5×11″ full page sticker sheet, cut, peel and stick on page near picture or word in the book. Select a variety of words: nouns, verbs, adjectives, prepositions, etc.

9) Iron-on symbol transfers for clothes and other material. Determine high frequency use words to be placed on the learning partner's or the learning student's T shirt, jeans or tote bag. Open a blank document on your computer and insert the selected symbols (available from CD or downloaded file). Print on 8.5×11″ iron-on transfer sheet (available from various vendors) and follow the vendor's directions for ironing onto fabric. Ideal for shirts, caps, bags, blankets and baby items.

10) PowerPoint booklet using 100 symbols. Open the PowerPoint demo (available from CD or downloaded file) and replace the symbols and family photographs with your own creations. Record your own narrative or voice.

11) PVC slant boards for device, pointers and switch supports can be constructed which allow greater access to symbols and devices for individuals with specific needs.

The learning method disclosed herein is particularly amenable to variations in the usage activities including (but not limited to) the below example:

1. Place a strip of soft sticky backed Velcro® on a paint stick or yardstick. Attach individual symbols in a sequence to match the words on each page.

2. Place individual symbols on a piece of indoor/outdoor carpeting (free samples from flooring stores) as the learning partner read with the learner/student.

3. Purchase 2 copies of the same book. Cut out target pictures and/or words, laminate and attach to corresponding pictures in the other copy. The same results can be achieved with a color copier. Combine these pictures by pressing the symbols on the voice output device.

4. Print multiple copies of symbols for repetitive lines throughout some stories. Select the individual symbols from symbol files and resize, print and laminate as needed.

5. Replace the main character of the story with a laminated photograph of the language learner/student.

### SYSTEM OPERATION

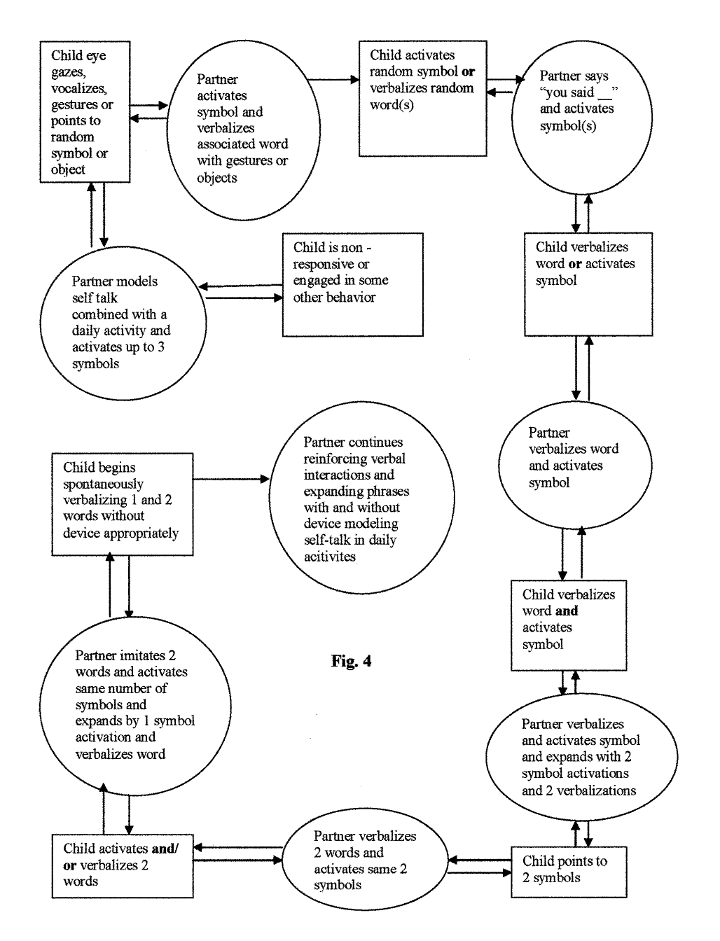

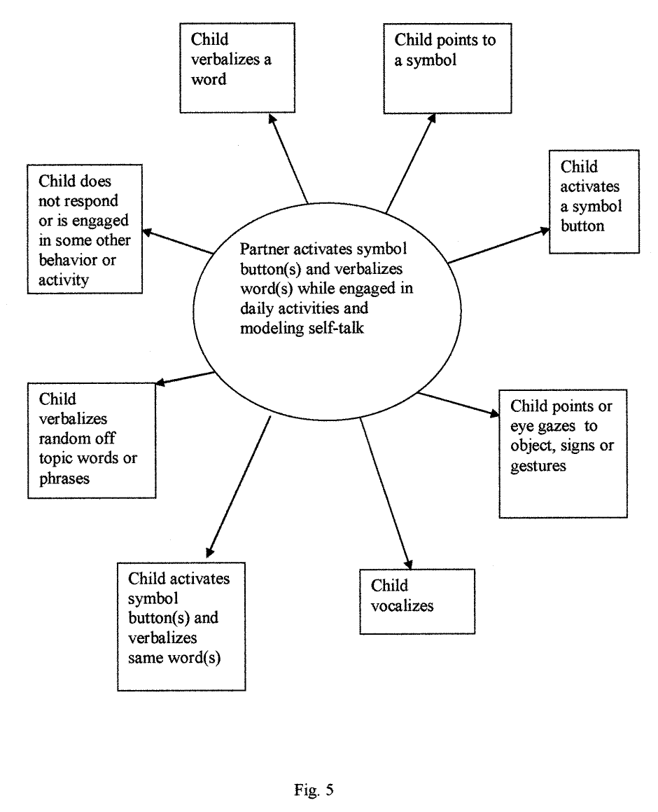

The voice output device 1, as presented in FIGS. 1-5, is provided with prerecorded word(s) (audio file 5) where each word corresponds to a switch/button 9 and a location on the overlay indicated with visual sound activating symbols 10 when used with the partner assisted communication method presented herein. When pressed, each symbol 10 activates a button 9 which provides the sound of a word (or words). The selected symbols may be combined to form a sequence of words to express the individual's wants, needs and desires. The static composition of these symbols with corresponding voice output locations is constant, reliable and predictable, providing a foundation for emerging verbal skills for both communication partners to use. It has the capacity to use words for all functions of language: to imitate, question, initiate, respond, comment, answer, describe, organize, predict, greet, retell, confirm, encourage, clarify, reject, remember, correct and persuade.

In the preferred embodiment of the present invention the words/symbol parings are permanent and cannot be erased, deleted or rerecorded, however it is envisioned that the words can be changed as needed by use of a sound module having re-recordable memory and that the corresponding symbols may also be changed.

The design of the visual display is essential to the function of the device. The symbols are simplistic in design, using basic shapes to convey meaning and eliminate distracting visual information. Parts of speech are color coded and arranged on the overlay into preferred groupings to reinforce both the meaning of the words being spoken by the audio file and the location on the overlay, for example nouns are yellow and are placed in the first 2 columns, verbs are green and comprise columns 3-5, prepositions are purple in columns 6 and 7, and adjectives are blue and positioned in columns 8 and 9. Clarifying words are white and placed in column 10 and around the perimeter of the overlay. Questions are grey and arranged in the top row of the overlay. Language typically develops first with nouns, then verbs, prepositions and adjectives as arranged from left to right on the overlay.

The preceding arrangement of groupings and color coding is exemplary. The voice output device 1 is particularly useful to fit a variety of language development needs. Development of questions comes later in the process of language learning and questions are placed on the top row of the overlay beginning with the word “what” because it is developmentally the first question word to be understood and expressed by typically developing children. Acquisition of question words progresses to “who, where, when, how, why” sequentially. Placement of the words: “you-your” at the upper left hand corner is critical. The ability to selectively format the arrangement and design of the visual display allows a learner to have words placed in a preferred location (such as the left hand corner).

People scan and read in English from left to right beginning at the top to bottom of visual material. The purpose of this tool is to focus on the learner and natural use of the word “you” (as opposed to “I”) to embed high frequency use of this word to engage the learner as quickly as possible. The one negative word, “not”, is red in color and placed in the lower left hand corner of the display. Foundation for emerging literacy skills are embedded in the arrangement of the symbols as students learn to visually scan from left to right and top to bottom. The printed word is added to the symbol to reinforce emerging literacy skills. Some language learners may identify with the printed word before the picture symbol, making it critical for their communication development.

The preferred embodiment presents 100 words which have been selected because they are generally considered to be the most frequently used and some of the first words children develop naturally. Some words have been omitted from the preferred embodiment because they do not enhance interactive social communication. Words such as “no, yes, hi, bye” are among the first words learned and are definitely powerful. Even though these words are most common, they do not promote conversation and can easily be communicated through means other than verbal expression. It is envisioned that these words may be used in alternate embodiments of the present invention.

In alternate embodiments of the present invention a few symbols have 2 words, “good, bad”. In context the meaning becomes clear, but also allows for flexibility of meaning and encourages use of “not”. For example, if something is “not bad”, it may also be “good”.

Peripheral words that may be associated with performing a specific activity (like working with arts and crafts) such as “glue, scissors, paper” are often not needed when using the voice output device 1. In normal daily activities people go for days without needing to express the word “glue” or “paper” therefore these and similar words are considered peripheral to daily communication activities. In contrast, people frequently use the words “put on” and “cut” throughout each day as well as during arts and crafts activities. The voice output device 1 reinforces the use of words such as “put on” and “cut” rather than the peripheral words because mastery of the more frequently used word is given priority over less often used peripheral words.

It is possible to retell basic stories using the core vocabulary of the voice output device 1 which it may not be grammatically correct, but conveys the appropriate meaning and provides information to the listener.

The voice output device 1 provides for a multi-sensory approach to language learning. The repetitive motor planning required to select a specific location along with the tactile feedback (touch) from pressing the symbol/button reinforces the muscle memory and association with the corresponding visual (symbol) and auditory (word) cues. Multiple activations of a single symbol/button for a variety of activities with different communication partners are important. The behavior reinforces the voice output from the device and the natural voice of the speaker. This process will make the necessary neurological connections in the brain for long term memory, thus increasing probability for verbal expression.

Whereas voice output devices currently available address the differences in language learners, the voice output method of the present invention identifies the similarities of language learners and allows for a natural integration into daily routines. While most language learning strategies have a “bottom-up” developmental model, building on small increments of language until a developmentally appropriate level is reached, the partner assisted voice output communication method of the present invention has a “top-down”, activity based model. This language learning strategy provides all the language from the beginning, gradually decreasing assistance from the partner and the voice output device 1 as the learner acquires increasing verbal skills necessary for effective interactive communication. The learner becomes less reliant on the voice output device 1 and more independent using natural voice.

Typically, once a speaker has achieved the ability to use 100 individual words and combine those words in 2-3 utterances to express novel ideas, expansion of verbal skills occurs naturally. Research reflects that voice output device usage does not inhibit natural verbal skill development, but rather increases the desire and skills required for natural verbal expression. Just as some children learn to walk before they crawl, some may say “stop” or “who” before “dada”. The partner assisted voice output communication method follows the child's lead and meets the child at the point of readiness to learn.

The voice output device 1 is a user oriented language development tool which can be configured to match each child or users learning patterns and learning needs.

The voice output device 1 is a powerful, engaging tool for children who are learning to talk, or who have difficulty mastering verbal expression. This interactive teaching device allows the child/learner—by pressing symbol/buttons—to see words, hear words, understand their meaning and experience the joy of communication. Together, teachers and learners will have fun learning to talk.

In a typical configuration this device contains 100 words most frequently used in conversation. Those words are recorded and paired with symbols that represent their meaning. Press a symbol and it speaks the corresponding word: “Happy.” Combine more than one word and the device expresses a complete thought: “I am happy.”

As the child/learner/student's learning partner and guide, the teacher will use this tool to enhance the learning process. The teacher's role is central: Initiate conversation, repeat words spoken by the device and by the child/learner, ask follow-up questions, and indicate an understanding of what the teachers are being told by the child/learner/student. Be consistent, practice daily. Soon the child/learner will realize words don't simply fly aimlessly through the air. Words have power.

### USAGE SUGGESTIONS

Suggested activities for partner assisted communication method interactions:

Getting dressed for the day

Mealtimes

Getting in and out of the car

Watching TV

Listening to music

Visiting family and friends

Cooking

Reading stories, singing songs, nursery rhymes

Playing with toys inside and outside the house

Playground

Getting ready for naptime or bed

With extended family members and friends

Making arts and crafts

Circle time at school

Transferring from one location or activity to another

Curriculum reinforcement: math, reading, science, history, writing

Sports activities, PE

Toileting, bathing and hygiene

Gardening

Bedtime

Discipline

Chores

Discussions of feelings

Visits to the doctor

Traveling

Dramatic play, construction play

Bubbles, blocks and balloon play

Begin with baby steps. Initially use only 1 and 2 word expressions: “I see.” “Look.” “You go.” Build vocabulary and comprehension slowly. Categories of words—nouns, verbs, adjectives, prepositions, questions—are grouped by color codes, reflecting the organization of language.

Expect your child has something to say. Look and listen for some form of communication: Gestures, eye gaze, pointing, attempts at speech and words. Give the child at least 10 seconds to respond after you have said something or asked a question. Use words within an activity (action) whenever possible.

Acknowledge the child's speech with repetition and a response: “You said, ‘Come Mommy.’ Here I come.” Position yourself in the front of the child so that your expressions enhance the communication.

Respond to all communication, even if it seems unintentional. If your child unwittingly points to the symbol for “thirsty”, respond with, “You said ‘thirsty,’ let's drink some water,” while pressing the symbols for “thirsty” and “drink.” This will build a sense of competence and self-esteem. Give positive feedback; repeat sounds and words expressed by the child. Take turns speaking.

Be genuine. Communicate a sincere desire for information. Asking questions the child thinks you already know the answer to—such as “What's my name?”—may result in no response or turning away.

Talk aloud to yourself. Use a different expression and tone for self-talk: “I am walking.” Be direct, use eye-contact when speaking to the child: “you are playing.” Talk about activities as they occur naturally. Caution: some children may find eye-contact over stimulating and shut down.

Give logical feedback. Don't say, “You touched the picture.” Do say, “You said ‘eat’.” Reinforce the communication by pressing the “eat” symbol and follow up by offering something to eat.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

What is claimed is:

1. A method for partner assisted language communications between a language learner/student and a language partner comprising:
providing a voice output device wherein the voice output device includes a sound output component for enunciating word/audio files, an overlay having sound activating symbols, and at least one activatable word/audio file which corresponds to each sound activating symbol;
performing an assessment of the language level of the language learner/student to determine language learning deficiencies or proficiencies;
generating or selecting a learning plan for the language learner/student to address language learning deficiencies or proficiencies identified in the assessment of the language learner;
implementing the learning plan;
monitoring the language learner/student's responses to the tasks of the learning plan;
assessing the language learner/student's responses to the tasks of the learning plan;
revising the learning plan to address language learning deficiencies or proficiencies identified in the assessment of the language learner/student's responses to the tasks of the learning plan;
implementing the revised learning plan.

2. The method of claim 1 wherein performing an assessment of the language level of the language learner/student includes:
selecting and documenting the words that reflect the current vocabulary of the language learner/student from among a predetermined group of words;
selecting from among a predetermined flow chart of interactive communication steps the best step that reflects the interactive communication level of the language learner/student during interactive communication activities; and
documenting the articulation level of the language learner/student by indicating on an articulation tracking form the position of selected portions of speech key sounds of words enunciated by the language learner/student during interactive communication activities and noting words incorrectly enunciated by the language learner/student.

3. The method of claim 2 wherein the tracked positions of selected portions of key speech sounds are the initial position, the medial position, and the final position,
wherein the tracked positions indicate whether the key speech sound is appropriately positioned at the initial (beginning) position of a word, the medial (middle) position of a word, or the final (end) position of a word when the word is enunciated correctly.

4. The method of claim 3 wherein generating a learning plan includes:
selecting at least one target word from the vocabulary of the language learner/student which was determined to be incorrectly enunciated during the assessment of the language level of the language learner/student;
selecting a task/activity for interactive communication between the language learner/student and the language partner which is suitable for use with the at least one target word and the voice output device.

5. The method of claim 4 wherein generating a learning plan further includes:
generating at least one supplemental training aid which focuses the language learner/student's attention on the at least one target word.

6. The method of claim 5 wherein the supplemental training aid is a template which selectively covers symbols from view.

7. The method of claim 4 wherein implementing the learning plan includes:
wherein the language partner initiates a conversation or the selected task/activity with the language learner/student which is intended to elicit the enunciation of at least one target word by the language learner/student.

8. The method of claim 7 wherein monitoring and assessing the language learner/student's responses to the tasks/activities of the learning plan includes additional documenting of the articulation level of the language learner/student by indicating on an articulation tracking form the position of selected portions of speech sounds of words enunciated by the language learner/student during the conversation or the selected task/activity and noting words incorrectly enunciated by the language learner/student.

9. The method of claim 8 wherein revising the learning plan includes:
selecting at least one target word determined to be incorrectly enunciated by the language learner/student; and
selecting an alternative task/activity for interactive communication between the language learner/student and the language partner which is intended to elicit the enunciation of the at least one target word by the language learner/student.

10. The method of claim 8 wherein revising the learning plan includes:
selecting at least one target word determined to be incorrectly enunciated by the language learner/student; and
selecting at least one alternative word wherein the tracked position of the key speech sound of the target word is enunciated at the same initial, medial, or final position of the alternative word when the alternative word is enunciated correctly.

11. The method of claim 8 wherein revising the learning plan includes:
selecting at least one target word determined to be incorrectly enunciated by the language learner/student;
selecting at least one alternative word wherein the tracked position of the key speech sound of the target word is enunciated at the same initial, medial, or final position of the alternative word when the alternative word is enunciated correctly; and
selecting an alternative task/activity for interactive communication between the language learner/student and the language partner which is which is intended to elicit the enunciation of the alternative word by the language learner/student.

12. The method of claim 8 wherein revising the learning plan includes:
selecting at least one target word based on the color of the sound activating symbol of the word wherein the symbols are arranged in pre-specified colors as well as row and column order with regards to nouns, verbs, prepositions, adjectives, clarifying words, and questions,
wherein nouns are presented in yellow and positioned in the left first two columns, verbs are presented in green and positioned in columns 3 thru 5, prepositions are presented in purple and positioned in columns 6 thru 7, adjectives are presented in blue and positioned in columns 8 thru 9, clarifying words are presented in white and positioned in column 10 and around the perimeter of the overlay, and questions are presented in grey and positioned in the top row of the overlay.

13. The method of claim 12 wherein revising the learning plan includes selecting an alternative task/activity for interactive communication between the language learner/student and the language partner which is intended to elicit the enunciation of the at least one target word by the language learner/student.

14. The method of claim 4 wherein generating a learning plan further includes:
selecting at least one target word based on the color of the sound activating symbol of the target word wherein the symbols are arranged in a plurality of columns and rows of sound activating symbols of pre-specified colors as well as row and column order with regards to nouns, verbs, prepositions, adjectives, clarifying words, and questions,
wherein nouns are presented in yellow and positioned in the left first two columns, verbs are presented in green and positioned in columns 3 thru 5, prepositions are presented in purple and positioned in columns 6 thru 7, adjectives are presented in blue and positioned in columns 8 thru 9, clarifying words are presented in white and positioned in column 10 and around the perimeter of the overlay, and questions are presented in grey and positioned in the top row of the overlay; and
generating at least one supplemental training aid template which selectively covers symbols from view so that only the selected at least one target word is visible.

15. The method of claim 14 wherein multiple colors of speech symbols are selected to form combinations of words thereby representing phrases, statements, or questions.

16. A voice output device for partner assisted language communications between a language learner/student and a language partner comprising:
a housing including a sound output component;
an overlay attached to the housing, the overlay containing at least one sound activating symbol,
wherein pressing the symbol activates a corresponding audio file thereby causing the sound output component to enunciate the sound of the word of the selected audio file;
wherein the overlay contains a plurality of columns and rows of sound activating symbols arranged in pre-specified colors and order with regards to nouns, verbs, prepositions, adjectives, clarifying words, and questions.

17. The voice output device of claim 16 wherein in the pre-specified order:
nouns are presented in yellow and positioned in the left first two columns;
verbs are presented in green and positioned in columns 3 thru 5;
prepositions are presented in purple and positioned in columns 6 thru 7;
adjectives are presented in blue and positioned in columns 8 thru 9;
clarifying words are presented in white and positioned in column 10 and around the perimeter of the overlay; and
questions are presented in grey and positioned in the top row of the overlay.

18. The voice output device of claim 17 wherein a template is provided which selectively covers symbols from view.

19. The voice output device of claim 18 wherein the template is configured to only selectively show either nouns, verbs, prepositions, adjectives, clarifying words, or questions.

20. The voice output device of claim 18 wherein the template is configured to only selectively show target and alternative word/symbols wherein a tracked position of a key speech sound of a target word is enunciated at the same initial, medial, or final position of the alternative word and the target word when the words are enunciated correctly.
